(19) United States
(12) Patent Application Publication
(10) Pub. No.: US 2009/0095105 A1
(43) Pub. Date: Apr. 16, 2009

(54) Gear and coupling system

(76) Inventor: John E. Hollender, Chicago, IL (US)

Correspondence Address: Susan D. Reinecke;Ice Miller LLP, Suite 3500, 200 W. Madison St., Chicago, IL, 60606, US

(21) Appl. No.: 11/974,302

(22) Filed: Oct. 12, 2007

(51) Int. Cl. F16H 1/16

(52) U.S. Cl. 74/425

(57) ABSTRACT

A gear system including a worm gear, planetary gear, worm coupling and planetary coupling is presented. The worm coupling couples a first shaft with the worm gear and includes a head and an elongated portion. The elongated portion is attached to the worm gear to serve as the worm gear's axle. The head includes an opening into which the worm shaft is inserted and may include additional bores into which set screws are inserted to removably attach the worm shaft to the worm coupling. The planetary coupling couples a second shaft with the planetary gear. The planetary coupling includes a bore into which the second shaft is inserted and may include additional bores into which set screws are inserted to removably attach the planetary shaft to the planetary coupling. By using multiple bores and set screws, the planetary coupling may accommodate a variety of planetary shafts.

### BACKGROUND

Worm and planetary gears work together to transfer rotational movement in one plane to another plane. The worm gear and planetary gear are placed in rotational engagement with each other so that the threads of the worm gear mesh with the teeth of the planetary gear. Thus, the longitudinal axis of the worm gear and that of the planetary gear are at right angles with each other so that rotational movement of one gear along its longitudinal axis is transferred to the other gear along its longitudinal axis and vice versa.

The worm gear/planetary gear combination may be used to transfer the rotational movement of one shaft or other body to that of another shaft or body. This may be accomplished by coupling one of the shafts to the worm gear and the other to the planetary gear. A coupling is used to couple the shafts to the gears. In general, the couplings are be separate elements, such as a nut or bearing, which must be separately attached to both the shaft and the gear. For example, the shaft may be inserted into the axel of the gear and held in place with a bearing.

### SUMMARY

A gear system including a worm gear, a planetary gear and couplings, which may be supported by a bracket, is presented. The worm gear includes a coupler (a “worm coupling”) integrated with the worm gear's axel. Thus, the axel and the coupler form one integrated element. To attach a shaft (the “worm shaft”) to the worm coupling and a shaft (the “planetary shaft”) to the planetary gear, the worm shaft and the planetary shaft are inserted into the worm coupling and the planetary coupling, respectively. Both couplings include bores through which set screws are inserted so that they engage the shafts. Thus, the shafts are held in place. Shafts of different sizes and shapes may be accommodated by the distance by which the set screws are inserted into the couplings.

The worm coupling includes a head and an elongated portion. The elongated portion may be inserted into and fixedly attached to the worm gear. In this manner, the elongated portion serves as the axle of the worm gear. The head of the worm coupling includes an opening into which the worm shaft is inserted and to which it is removably attached. To attach the worm shaft to the worm coupling, the head may include one or more bores into which set screws may be inserted so that they contact the worm shaft. The cross-sectional shape of the coupling and the worm shaft are generally complementary.

The planetary coupling couples a shaft (the “planetary shaft”) with the planetary gear. The planetary coupling includes a bore into which the planetary shaft may be inserted and to which it is removably attached. To attach the planetary shaft to the planetary coupling, the planetary coupling may include one or more bores into which set screws may be inserted so that they contact the planetary shaft. By using a multiple of bores and set screws, such as four, the planetary coupling may accommodate planetary shafts with cross-sections significantly different and/or smaller than that of the planetary coupling. The cross-sectional shape of the coupling and the worm shaft may be complementary, however, this is not necessary.

### DESCRIPTION THE DRAWINGS

The invention can be better understood with reference to the following drawings and description. The components in the figures are not necessarily to scale, emphasis instead being placed upon illustrating the principles of the invention. In the drawings:

FIG. 1. is an isometric view of a gear and coupling system mounted on a bracket;

FIG. 2 is a front plan view of the gear and coupling system mounted on a bracket shown in FIG. 1;

FIG. 3 is an isometric view of a the gear and coupling system mounted on a bracket shown in FIG. 1 receiving a first and second shaft;

FIG. 4 is a front plan view of a the gear and coupling system mounted on a bracket shown in FIG. 1 receiving a first and second shaft;

FIG. 5 is an exploded isometric view of the coupling, first shaft and worm gear shown in FIG. 3;

FIG. 6 is an isometric view of the coupling, first shaft and worm gear shown in FIG. 3;

FIG. 7 is an isometric view of the gear and coupling system shown in FIG. 3 in operative communication with plenums in a duct.

### DETAILED DESCRIPTION

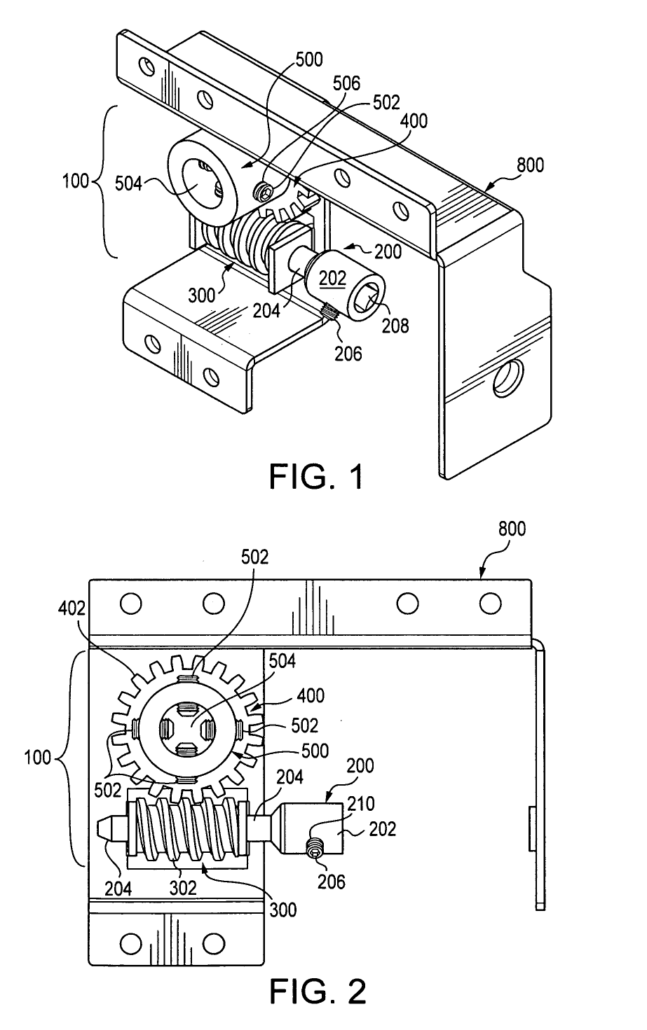

A gear and coupling system is shown in FIGS. 1 and 2. The system 100 generally includes a worm gear coupling 200, worm gear 300, planetary gear 400 and planetary gear coupling 500. As shown in FIGS. 1 and 2, the system 100 may be mounted on a bracket 800. The bracket 800 may include configurations that maintain the functional relationship among the elements of the system 100. The worm gear 300 and the planetary gear 400 are mounted at right angles to each other so that the threads 302 of the worm gear 300 intermesh with the teeth 402 of the planetary gear 400. In this arrangement, rotation of the worm gear 300 around its longitudinal axis will cause the planetary gear 400 to rotate around its longitudinal axis, and vice versa.

The worm gear coupling 200 includes a head 202 and an elongated portion 204. The worm gear 300 is coaxially attached around the elongated portion 204 along the longitudinal axis of the elongated portion 204. Thus, the elongated portion 204 serves as the axle of the worm gear 300 in one integrated element. The head 202 includes a bore 210 for receiving a set screw 206. Although one bore 210 and one set screw 206 are shown, a variety and number of bores 210 and set screws 206 may be included. The head also includes an opening 208.

The planetary gear coupling 500 is fixedly and coaxially attached to the planetary gear 400. The planetary gear coupling 500 may include a number of bores 506 for receiving a number of set screws 502. Although four bores 506 and set screws 502 are shown in FIGS. 1 and 2, a variety and number of bores 506 and set screws 502 may be included.

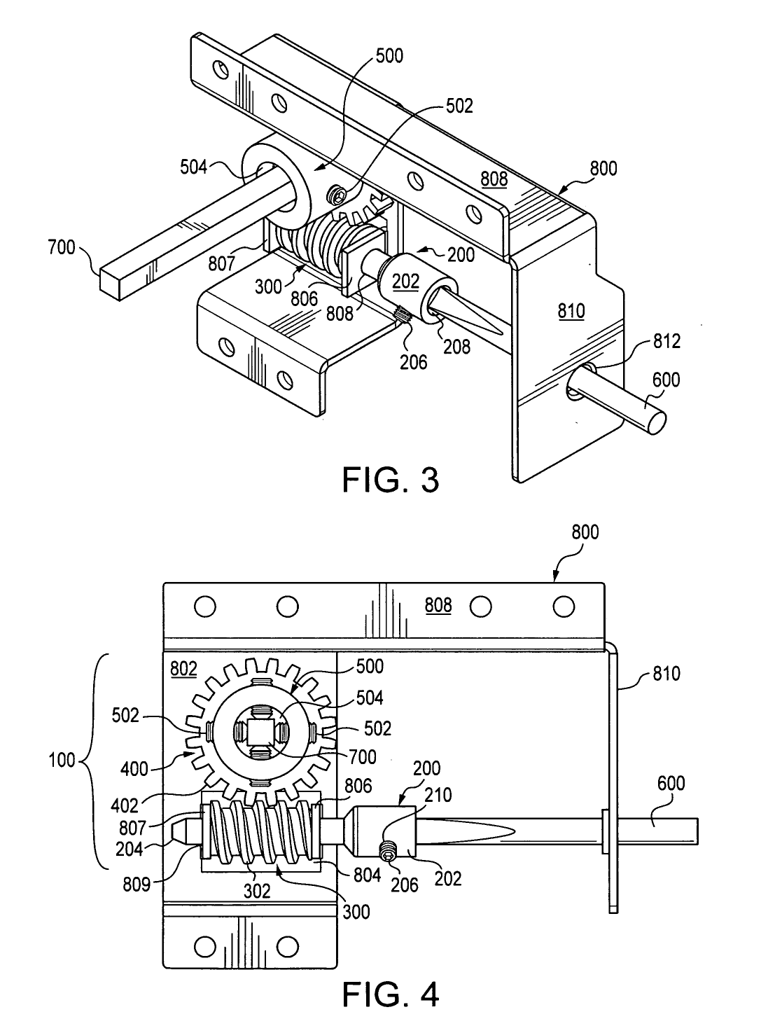

The gear and coupling system 100 may be used to translate the rotational motion of one body to another body along a different axis. For example, as shown in FIGS. 3 and 4, the system 100 may be used to translate the rotational movement of one shaft (a worm shaft 600) around the longitudinal axis of the worm gear 300 to another shaft (a planetary shaft 700) around the longitudinal axis of the planetary gear 400. The worm shaft 600 may serve as the drive shaft for the system 100. The worm shaft 600 and the planetary shaft 700 may be a rigid or flexible body, such as a flexible cable.

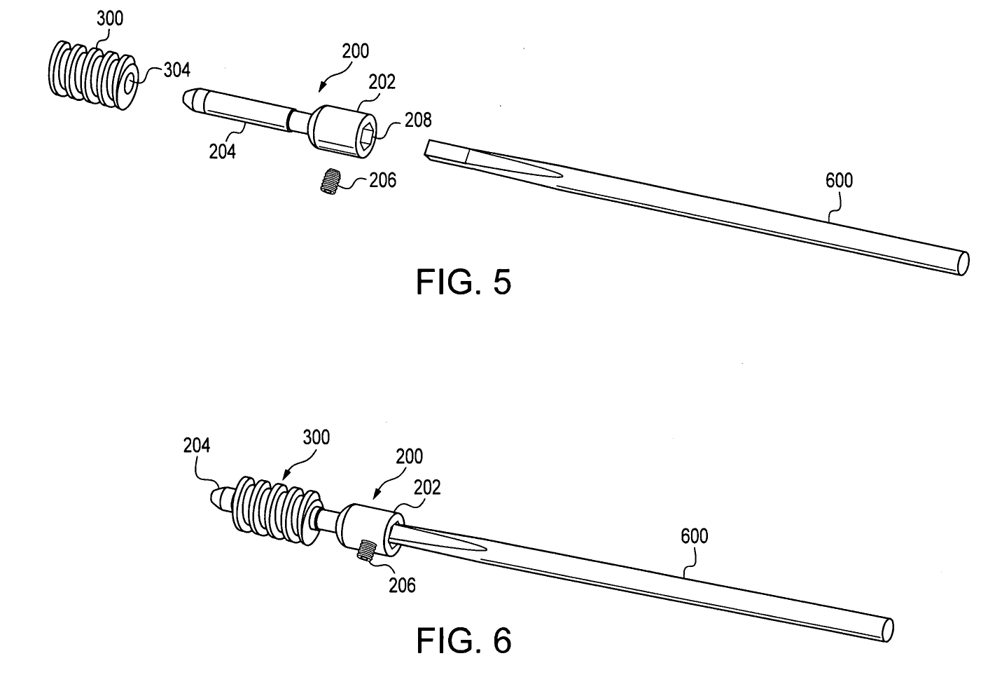

The worm shaft 600 may be removably coupled to the worm gear 300 via the worm coupling 200. As shown in FIGS. 5 and 6, the elongated portion 204 of the worm coupling 200 is inserted into the bore 304 in the worm gear 300. For example, the elongated portion 204 of the worm coupling 200 may be knurled and slightly larger in diameter than the bore 304. The elongated portion 204 is press fit into the worm gear 300. To couple the worm shaft 600 with the worm gear 300, the worm shaft 600 is inserted into the opening 208 in the head 202 of the worm coupling 200 and secured therein by one or more set screws 206. In addition to coupling the worm shaft 600 with the worm gear 300, the worm coupling 200, particularly the elongated portion 204, serves as the axle of the worm gear 300. Thus, rotation of the worm shaft 600 will cause the worm gear 300 to rotate along its longitudinal axis.

Referring again to FIGS. 3 and 4, the planetary shaft 700 may be removably coupled with the planetary gear 400 via the planetary coupling 500. The planetary shaft 700 is inserted into the bore 504 in the planetary coupling 500 and secured therein by the set screws 502. As shown in FIGS. 3 and 4, the planetary coupling 500 includes four bores 504 and four set screws 502.

The opening 208 in the worm coupling 200 may have a variety of cross-sectional shapes, which are generally complementary to the shape of the cross-section of the worm shaft 600. For example, as shown in FIG. 5, the opening 208 and the cross-section of the worm shaft 600 proximate to the worm coupling 200 has a square shape. Alternately, the opening 208 and the cross-section of the worm shaft 600 may have other shapes for example, circular or hexagonal. The bore 504 in the planetary coupling 500 may have a circular cross-section, which may receive planetary shafts 700 of various cross-sectional shapes, such as circular, square (which is shown in FIGS. 3 and 4) and hexagonal. By using a multiple of bores 504 and set screws 502, such as four, the planetary coupling 500 may accommodate planetary shafts 700 with cross-sections significantly smaller than that of the planetary coupling 500.

The system may be supported by a bracket 800. One example of such a bracket 800 is shown in FIGS. 1-4. As shown in FIGS. 3 and 4, the bracket may include a lower support 802, a side support 808 and an end support 810. The worm gear 300 and the planetary gear 400 are supported by the lower support 802. The planetary gear 400 is secured to the lower support 802 so that its longitudinal axis is about perpendicular with the lower support 802. The planetary gear 400 may go through a bore 504 in the lower support 802 and be attached to the bore 504 via a snap ring (not shown) located on the side of the lower support 802 opposite the planetary coupling 500. The lower support 802 includes a pair of protrusions 806 and 807 that support the worm gear 300. The protrusions 806 and 807 each include a bore 808 and 809, respectively, through which the axle of the worm gear 300 (the elongated portion 204 of the worm coupling 200) is inserted. To secure the worm gear 300 to the bracket 800, the elongated portion 204 may be knurled and press fit into one protrusion 806, the worm gear 300 and the other protrusion 807, respectively. The worm gear 300 and the planetary gear 400 are located on the lower support 802 of the bracket 800 in such proximity with each other so that the threads 302 of the worm gear 300 mesh with the teeth 402 of the planetary gear 400.

The side support 808 of the bracket 800 attaches the lower support 802 to the end support 810 so that the end support 810 faces the lower support 802. The end support 810 may include a bore 812 through which the worm shaft 600 may protrude. This arrangement provides support to the worm shaft 600 and aligns the longitudinal axis of the worm shaft 600 with that of the worm coupling 200.

The bracket 800 may be manufactured from a material such as metal or engineered plastic. The bracket 800 may be made from a single piece of material (for example, stamped in one piece from a single sheet of metal) and folded to obtain the desired shape. Alternately, the components of the bracket 800 may be manufactured separately and secured together via, for example, welding, screwing and/or soldering.

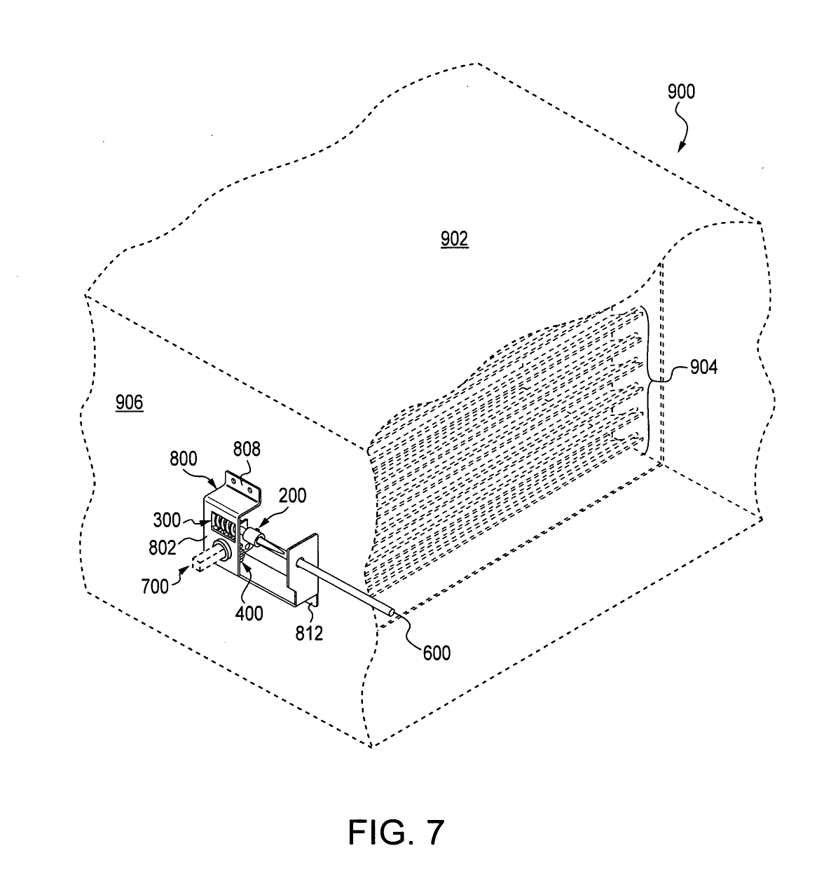

One application for which the gear and coupling system 100 may be used is shown in FIG. 7. In this example, the gear and coupling system 100 is used to control the motion of a damper 904 within a plenum 900, such as a heating, ventilation and air conditioning (HVAC) duct. In the plenum 900, air flow is controlled by the position of the dampers 904. If the dampers 904 are positioned so that they are parallel with the top 902 of the plenum, the maximum amount of air is permitted to flow. In contrast, if the dampers 904 are positioned so that they are parallel with the side 906 of the plenum, air is prevented from flowing through the plenum 900. Movement of the dampers 904 is controlled by the rotation of the planetary shaft 700.

Due to the size and the shape of the aperture 504 and set screws 502 (see FIG. 3) in the planetary coupling 500, planetary shafts 700 of different sizes and shapes may be accommodated. For example, the aperture 504 and set screws 502 (see FIG. 3) may accommodate a 0.25 or 0.375 inch square shaft. Alternately, the aperture 504 and set screws 502 (see FIG. 3) may accommodate 0.25 or 0.5 inch round shaft 700.

Such plenums 900 may be located in areas that are not conveniently or easily accessible. For example, the plenum 900 may be located in a ceiling, wall or floor. Therefore, some type of device is needed to enable the dampers 904 to be remotely controlled. This device may include a worm shaft 600. The worm shaft 600 may include, for example, a flexible or non-flexible cable. If the plenum 900 is installed in a ceiling, the worm shaft 600, which is in communication with the worm coupling 200, may protrude from the ceiling. Thus, the dampers 904 may be controlled by rotating the protruding worm shaft 600.

While various embodiments have been described, it will be apparent to those of ordinary skill in the art that many more embodiments and implementations are possible within the scope of the invention. Accordingly, the invention is not to be restricted except in light of the attached claims and their equivalents.

What is claimed is:

1. A gear system comprising:
a first coupling including an elongated portion and a head that includes
an opening configured to receive a first shaft;
a bore configured to receive a set screw and wherein the set screw is configured to releasably attach the first shaft with the first coupling;
a worm gear integral with the elongated portion of the first coupling; and
a planetary gear in rotational engagement with the worm gear; and
second coupling attached to the planetary gear and configured to releasably attach a second shaft with the planetary gear.

2. A gear system comprising:
a first coupling including an elongated portion and a head that includes an aperture, wherein the aperture is configured to receive a first shaft;
a worm gear integral with the elongated portion of the first coupling; and
a planetary gear in rotational engagement with the worm gear.

3. The system of claim 2, wherein the head of the first coupling includes a first bore configured to receive a first set screw and wherein the first set screw is configured to releasably attach the first shaft with the first coupling.

4. The system of claim 2 further comprising a second coupling attached to the planetary gear and configured to releasably attach a second shaft with the planetary gear.

5. The system of claim 4, wherein the second coupling includes a plurality of second bores configured to receive second set screws and wherein the second set screws are configured to releasably attach the second shaft with the second coupling.

6. The system of claim 4, wherein the second coupling includes four second bores configured to receive four second set screws and wherein the second set screws are configured to releasably attach the second shaft with the second coupling.

7. The system of claim 2 further comprising a bracket to which the worm and planetary gears are mounted.

8. A gear system comprising:
a worm gear;
a first coupling including an elongated portion and a head that includes a bore, wherein the bore is configured to receive a first shaft and wherein the elongated portion serves as an axle for the worm gear; and
a planetary gear in rotational engagement with the worm gear.

9. A plenum control system comprising:
a gear system including:
a first coupling including an elongated portion and a head that includes a bore, wherein the bore is configured to receive a first shaft;
a worm gear integral with the elongated portion of the first coupling;
a first shaft removably attached to the worm gear;
a planetary gear in rotational engagement with the worm gear; and
a second coupling attached to the planetary gear;
a second shaft operatively coupled with a damper in the plenum and the second coupling;
